(19) United States
(12) Patent Application Publication
(10) Pub. No.: US 2022/0090846 A1
(43) Pub. Date: Mar. 24, 2022

(54) SWING DOOR SYSTEM AND DEVICE WITH A SWING DOOR SYSTEM

(71) Applicants: SCHOTT AG, Mainz (DE); SCHOTT Flat Glass CR, s.r.o., Valesske Mezirici (CZ)

(72) Inventors: Petr SMAJSER, Stramberk (CZ); Martin RAFAJ, Vsetín (CZ); Jochen DIEDERICHS, Mainz (DE)

(73) Assignees: SCHOTT AG, Mainz (DE); SCHOTT Flat Glass CR, s.r.o., Valasske Mezirici (CZ)

(21) Appl. No.: 17/543,583

(22) Filed: Dec. 6, 2021

Related U.S. Application Data
(63) Continuation of application No. PCT/EP2020/057100, filed on Mar. 16, 2020.

(30) Foreign Application Priority Data
Jun. 6, 2019 (EP) 19 178 880.1

(51) Int. Cl. F25D 23/02; F25D 27/00

(52) U.S. Cl. CPC F25D 23/028; F25D 27/00

(57) ABSTRACT

The present disclosure relates to a swing door system, preferably for use with a chiller device or freezer device, including at least one swing door, a mullion and a sealing element. The at least one swing door includes a transparent pane and the sealing element is arranged between the swing door and the mullion in a closed position of the swing door. The mullion is translucent at least in part.

### CROSS-REFERENCE TO RELATED APPLICATION

The present application is a continuation under 35 U.S.C. § 120 of International Patent Application No. PCT/EP2020/057100, filed on Mar. 16, 2020, which in turn claims priority to European Patent Application No. EP 19178880.1, filed on Jun. 6, 2019, each of which is incorporated by reference.

### BACKGROUND OF THE DISCLOSURE

### 1. Field of the Disclosure

The present disclosure relates to a swing door system, preferably for use with a freezer or chiller device, comprising at least one swing door and a mullion, wherein the swing door comprises a transparent pane.

The present disclosure further relates to a freezer or chiller device comprising a swing door system.

The present disclosure further relates to a swing door arrangement comprising a swing door system.

Although applicable to any kind of device with a swing door system, the present disclosure will be described with regard to a swing door system of a freezer device.

### 2. Discussion of the Related Art

Conventional freezer devices can be found in super markets, convenience stores or the like to provide frozen products for customers, usually being presented on shelves inside the freezer device. Such freezer devices usually comprise a cabinet and a plurality of swing doors, which can be opened in horizontal direction by a customer, i.e. by rotating the swing doors around a vertical axis. The swing doors further have circumferential sealings providing a sealing function between the inner of the freezer device and its outside. The sealings attached to the swing doors can comprise magnets to provide a magnetic force-locking connection with mullions and horizontal profiles of the freezer device. This avoids leakage of ambient warm air from the outside of the freezer device into the inside and therefore avoids unnecessary energy consumption for cooling as well as icing and condensation inside the freezer device. Further, the swing doors usually comprise large glass panes so that a customer can view the products from outside without having to open the swing doors.

However, most of the freezer devices are arranged with their shelves parallel to the aisles of the supermarket. Due to the mullions of the freezer device, i.e. vertical profiles, a person, when walking down the aisle, has an angled and very limited view on the products within the freezer device, since the mullions block a non-neglectable part of the total view of a customer on these products.

### SUMMARY OF THE DISCLOSURE

Embodiments of the disclosure therefore address the problems of providing an enhanced comfort for customers when accessing a freezer or chiller device while providing a sufficient sealing function between the inside and outside of a freezer or chiller device together with a sufficient mechanical robustness, flexibility in terms of applicability and implementation and a high visibility of goods from outside the freezer device.

In an embodiment, the present disclosure provides a swing door system, preferably for use with a chiller device or freezer device, comprising at least one swing door, a mullion and a sealing element, wherein the at least one swing door comprises a transparent pane and wherein said sealing element is arranged between the swing door and the mullion in a closed position of said swing door, wherein said mullion is at least translucent at least in part.

In a further embodiment, the present disclosure provides a freezer or chiller device, comprising a swing door system according to one of the claims 1-13 being arranged in a cabinet and having a further swing door and/or a swing door arrangement according to claim 15, preferably wherein said swing doors of the swing door system and/or the swing door arrangement are arranged such to open in the same direction of the aperture angle, or preferably wherein the swing doors of the swing door system are arranged such to open in opposite aperture angle directions.

In a further embodiment, the present disclosure provides a swing door arrangement comprising a swing door system according to one of the claims 1-13, a further sealing element and a further swing door, wherein said further swing door comprises a transparent pane and wherein said further sealing element is arranged between said further swing door and said mullion in a closed position of said further swing door.

The term “freezer device” refers in particular in the claims, preferably in the description to a device in which the temperature of the foodstuffs is typically kept between −12° C. and −30 ° C. on normal conditions of use. Normal conditions are defined as operating conditions, which exist when the cabinet, including all permanently located accessories, has been set up and situated in accordance with the recommendations of the manufacturer and is in service. Typical examples for such foodstuffs are the products which are stored according to EN23953, part 2 (September 2012) in the temperature classes L1, L2 and L3.

The term “chiller device” refers in particular in the claims, preferably in the description to a device in which the temperature of the foodstuffs is typically kept between −5° C. and +10° C. on normal conditions of use, preferably between 0° C. and +7° C. Typical examples for such foodstuffs are the products which are stored according to EN23953, part 2 (September 2012) in the temperature classes M1 and M2.

The term “mullion” refers in particular in the claims, preferably in the description to a vertical profile of a freezer device where a door is arranged in a cabinet and wherein the mullion is not a vertical side profile of an outer frame, but an “inner” vertical profile in particular arranged in the area of two adjacent doors.

The term “transparent” refers in particular in the claims, preferably in the description to a region, area or the like which is optically provided such that the view on the goods, products or the like inside the freezer or chiller device is not obstructed or blocked by one or more opaque elements of the freezer or chiller device, for example by spacers, profiles, gaskets, a mullion or by the swing doors. The term “transparent” or “transparency” according to embodiments of the present disclosure may include the following definition: Transparency of an element means that light can pass said element without being scattered, in particular enable application of Snell's law for the light path and/or enables image formation.

The term “non-transparent” refers in particular in the claims, preferably in the description to a region, area or the like which is optically provided such that the view on the goods, products or the like inside the freezer device is obstructed or blocked by one or more opaque elements of the freezer device, for example by spacers, profiles, gaskets, a mullion or by the swing doors.

The term “translucent” refers in particular in the claims, preferably in the description to a region, area or the like which is optically provided such that the view on goods, products or the like inside the freezer device is not obstructed or blocked but being diffuse, for instance the dimensions of a product can be seen, but not any labeling of the product, at least not clearly. Transparent materials may appear clear, with the overall appearance of one color, or any combination.

The term “at least” with regard to the term “translucent” means in particular in the claims, preferably in the description that e.g. the optical visibility of products behind an at least translucent element is translucent or greater or better, i.e. between translucent and transparent, or in other words the optical visibility of products behind an at least translucent element is improved. The term “at least translucent” includes therefore “transparent”.

The term “width” refers in particular in the claims, preferably in the description, to a length measured in the plane in which the swing doors are arranged when the swing doors are in a closed position.

The terms “depth” or “thickness” refer in particular in the claims, preferably in the description, to a length measured in the plane being perpendicular to the plane in which swing doors are arranged when the swing doors are in the closed position.

The term “vertical” refers in particular in the claims, preferably in the description, to the direction aligned with the direction of the force of gravity, up or down, as materialized with a plumb line.

The term “horizontal” refers in particular in the claims, preferably in the description, to the direction perpendicular to the vertical direction. For instance, a horizontal profile is a profile of the device extending in the horizontal direction, in other words parallel to the surface of the earth.

The term “essentially” with regard to the terms relating to a shape, form or the like of an element refers in particular in the claims, preferably in the description, not only to the strict form, shape or the like but also to a shape, form or the like which deviates from the strict form, for instance by rounded corners, different formed connections between corners or the like.

One of the advantages is that in particular the angled view or the view directly in front of the freezer device or chiller device on the products is not blocked and therefore the comfort for customers is increased. A further advantage is, that a cost-effective implementation can be provided. A further advantage is that support, stability and stiffness of the freezer or chiller device can be enhanced due to the mullion.

Further features, advantages and preferred embodiments are disclosed or may become apparent in the following.

According to an embodiment, said mullion is transparent at least in part. This further enhances the comfort for customers and enhances their view on products. Interesting products can be seen also from a larger distance, enabling a target-oriented shopping for customers avoiding a time-consuming search for their products.

According to a further embodiment, a material and/or structure providing mechanical stability of said mullion is at least translucent at least in part, preferably at least in part transparent. This further enhances the comfort for customers and enhances their view on products.

According to a further embodiment, said mullion is fully transparent. This even further enhances the comfort for customers and their view on products.

According to a further embodiment, said sealing element is at least translucent at least in part. This avoids a blocking of the view of customers due to a non-transparent sealing element. In other words, the view on products of freezer devices and chiller devices is further enhanced.

According to a further embodiment, said sealing element is compressible. This enables a reliable sealing function between inside and outside of a chiller or freezer device, since small deviations between the surfaces of a swing door and a mullion can be compensated.

According to a further embodiment, said mullion and/or said sealing element comprises at least one force-locking element providing a force-locking connection between said mullion and said at least one swing door. This enables a reliable but simple locking mechanism for the swing door with the mullion.

According to a further embodiment, said force-locking element of said sealing element is arranged at the lower and/or upper vertical section of said swing door and/or in the area of a handle. When said force-locking element is arranged in the upper and/or lower vertical section of a swing door, the view for a customer is usually not blocked by said force-locking element. The same applies by arranging the force-locking element in the area of a handle for opening the swing door. Usually the handle is opaque and therefore a further view blocking by the force-locking element is avoided.

According to a further embodiment, said force-locking element is a magnet, preferably a permanent magnet. This enables a very reliable sealing function between said swing door and said mullion. The sealing function may be further enhanced by arranging in a step-by-step manner permanent magnets within the mullion and/or sealing element. Alternatively, or additionally said sealing element may comprise a horizontal section and/or an additional sealing arranged preferably along the horizontal interface between a swing door element or an area and an outer horizontal frame profile or a cabinet structure providing a sealing of the corresponding door with the frame profile or the cabinet structure.

According to a further embodiment, said force-locking element is provided in form of a plurality of particles, preferably distributed, in particular uniformly, at least in part within the sealing element. This provides a reliable force-locking connection without solid large elements blocking the view for customers.

According to a further embodiment, said at least one swing door and/or said mullion comprise a heating element, preferably in form of a heating wire and/or heating cable. For example, a heating element can prevent condensation of the transparent regions of a swing door by heating corresponding part of the mullion and/or the swing door and light elements can illuminate products. A wire or cable is thin with respect to the mullion or the sealing element and therefore blocking of the view by said wire or cable on products is minimized.

According to a further preferred embodiment, said sealing element and/or said mullion is formed translucent in part to hide said heating element. This enhances the optical impression for a customer by avoiding direct view on the view blocking element, here in form of the heating element.

According to a further preferred embodiment, said swing door system comprises a reflective element, preferably in form of a mirror element and/or a reflective coating. This enhances the optical impression for a customer by blocking the view on a non-transparent element, for instance a heating element or the like. Due to the reflective property the view of the consumer is distracted from the non-transparent element and the consumer is provided with an enhanced overall optical impression.

According to a further preferred embodiment, said at least one swing door and/or said mullion comprise a light element, preferably in form of LED light strip. This enables illumination of products behind the swing door and/or the mullion.

According to a further preferred embodiment, said swing door comprises a gas-filled insulating glass unit or a vacuum glass unit, said gas-filled insulating glass unit or said vacuum glass unit comprises at least two glass panes being spaced apart from each other by a spacer element, preferably wherein said spacer element is at least partially translucent, preferably at least partially transparent. This provides a high appealing design of the swing door while providing a high thermal insulation. Said gas-filled insulating unit can comprise air and/or a one or more noble gases. An at least translucent, preferably at partially transparent, spacer element enhances the view of customers on products behind the swing doors since there is no blocking of the view by non-transparent spacers.

According to a further preferred embodiment, said at least one swing door and/or said mullion comprise a hollow profile. A hollow profile enables a flexible, light-weight and cost-sensitive swing door or part of it and/or of the mullion.

According to a further preferred embodiment, said heating element and/or said light element is arranged inside said hollow profile of said at least one swing door and/or said mullion. This enables a space-saving arrangement of further functional elements like said light element, heating element or the like.

According to a further preferred embodiment, said hollow profile of said at least one swing door is arranged between at least one glass pane forming said transparent pane of said at least one swing door and said sealing element. This enables a space-saving arrangement of the profile while providing support for said sealing element.

According to a further preferred embodiment, said at least one swing door comprises at least two glass panes, wherein one pane extends perpendicular to an opening direction of said at least one swing door over the other glass pane, and wherein said hollow profile is attached in the extending region of said extending glass pane. One of the advantages is that a protection for the glass panes or in general the swing door can be provided. A further advantage is that further functional elements can be arranged with or inside said hollow profile near the mullion in a closed position of the swing door.

According to a further preferred embodiment, said hollow profile and said mullion have essentially the same cross-sectional shape. This enables easy manufacturing and easy alignment of the surfaces of the hollow profile and the mullion.

According to a further preferred embodiment, said mullion and/or hollow profile have an essentially rectangular, essentially triangular or essentially t-shaped cross-section. On the one hand this enables an easy and cost-effective manufacturing of said mullion and said hollow profile. On the other hand, this enables in particular an easy alignment of surfaces of said hollow profile and said mullion.

According to a further preferred embodiment, said sealing element is attached to said mullion. This enables a simpler construction of the swing door.

According to a further preferred embodiment, a rotating axis of said at least one swing door is in the center of said at least one swing door, said center being defined with respect to the thickness of said at least one swing door perpendicular to the opening direction in a closed position of said at least one swing door or wherein the rotating axis of said at least one swing door is off the center of said at least one swing door, said center being defined with respect to the thickness of said at least one swing door perpendicular to the opening direction in a closed position of said at least one swing door. The latter enhances the flexibility in terms of the swing door, since only a neglectable part of the swing door moves to the inside, that means opposite to the opening direction when being opened. Such a part may block the adjacent swing door or requires a larger distance to the adjacent swing door so that it can be opened. The former provides an easy opening of said swing door without interfering with an adjacent swing door.

According to a further preferred embodiment of the freezer or chiller device, said freezer device comprises an upper and/or lower horizontal element to provide a stop for the at least one swing door of said swing door system and/or to provide a part for a force-locked swing door at the freezer or chiller device and/or wherein said freezer or chiller device comprises an energy source for providing heat and/or electric energy and an interface for connecting a heating element, a light element or a sensor of the swing door system to said corresponding energy source. This enhances the flexibility of the swing door system. For example, a heating element can prevent condensation of the transparent regions of a swing door or light elements can illuminate products.

According to a further preferred embodiment of the swing door arrangement, said swing doors form a common plane in a closed position and said mullion provides a single common surface for said sealing elements of said swing doors. This enables easy manufacture and alignment of the sealing elements or gaskets with said mullion.

According to a further preferred embodiment of the swing door arrangement, said swing doors form a common plane in a closed position and said mullion provides different surfaces for said sealing elements of said swing doors, preferably said different surfaces are inclined to each other. This enhances flexibility in terms of the position of the sealing elements while enabling reduction of squeezing of the sealing elements when opening the swing door.

According to a further embodiment, at least one of the swing doors comprises hinges at opposite ends of said at least one swing door for providing opening and closing by rotation about a rotating axis. This enables a simple and reliable attachment of the swing doors for instance in a cabinet or the like for providing rotational movement of the swing doors. The hinges can provide a self-closing mechanism for the respective swing door, e.g. based on a torsion spring closing system, a hydraulic closing system and/or a gravity closing system using the force of gravity for closing the respective swing door.

According to a further embodiment, a transparent pane of at least one of said adjacent swing doors comprises a gas-filled insulating glass unit (IG) or a vacuum insulated glass unit (VIG). This provides the advantage that the inside of the freezer device is insulated against the warm ambient air. Typically, the gas-filled insulating glass unit and/or the vacuum insulated glass unit comprises at least two glass panes, often three glass panes, being spaced apart from each other by one or more spacers or spacer elements. The glass panes can comprise a thickness of 3 mm to 5 mm, often 4 mm and/or may comprise an antifog-coating or an antifog foil and/or a heatable coating and/or a low-emissivity coating and/or an anti-reflective coating. In vacuum insulation glass units (VIG), the spacer elements can have a depth of 0.5 mm to 1.5 mm, preferably of below 1 mm. These spacer elements of the VIG are used in combination with a circumferential edge sealing. In gas filled insulation glass units (IG), the circumferential spacer elements can have a depth of 4 to 20 mm. The space between the glass panes can be filled with a gas in case of an insulating glass unit (IG) or can be evacuated in case of a vacuum insulated glass unit (VIG). For not obstructing the view through the glass units, the spacers can be made of a transparent material. Generally, the transparent pane of said swing doors can comprise several glass panes one above the other.

According to a further embodiment, preferably when a swing door comprises a gas filled insulation glass unit a thickness of a swing door with at least one sealing is equal to or smaller than 40 mm, preferably equal to or smaller than 30 mm, in particular equal to or smaller than 26 mm, said thickness is measured in a handle-free region parallel to the opening direction in a closed position of said swing door and/or a width of a region in a closed position of said swing door comprising at least one sealing, a center of said rotating axis of at least one of said swing doors, preferably further comprising at least one profile and spacer elements for spacing apart panes of a swing door, said width being measured perpendicular to the opening direction in a closed position of said swing door and parallel to the plane of said panes of said swing door, is equal to or smaller than 50 mm, preferably equal to or smaller than 41 mm, in particular equal to or smaller than 34 mm. This reduces the blocking of an angled view for customers, i.e. the angled view for customers is enhanced on the products when looking through the swing doors. The dimensions of a handle for opening of the swing door are not included when measuring the thickness or width of a swing door. In other words, the minimal distance between the transparent regions of the different adjacent swing doors may be defined as width. Thickness and width are measured in any given height of the transparent panes.

According to a further embodiment, preferably when a swing door comprises a vacuum insulation glass unit the thickness of a swing door with at least one sealing is equal to or smaller than 35 mm, preferably equal to or smaller than 25 mm, in particular equal to or smaller than 20 mm, preferably equal to or smaller than 16 mm, said thickness is measured in a handle-free region parallel to the opening direction in a closed position of said swing door and/or a width of a region in a closed position of said swing door comprising at least one sealing, a center of said rotating axis of at least one of said swing doors, preferably further comprising at least one profile and spacer elements for spacing apart panes of a swing door, said width is measured perpendicular to the opening direction in a closed position of said swing door and parallel to the plane of said panes of said swing door, is equal to or smaller than 50 mm, preferably equal to or smaller than 41 mm, in particular equal to or smaller than 34 mm, preferably equal to 28 mm, This reduces the blocking of an angled view for customers, i.e. the angled view for customers is enhanced on the products when looking through the swing doors.

According to a further embodiment of the freezer or chiller device, the swing doors of the swing door system are arranged such to open in the same direction of the aperture angle i.e. all doors are left-side hinged or all doors are right-side hinged. This provides a very simple handling in particular opening and closing of the swing doors since the customer is only confronted with swing doors opening in the same way.

According to a further embodiment of the freezer or chiller device, the swing doors of the swing door system are arranged such to open in the opposite aperture angle directions, i.e. for two adjacent doors one is left-side hinged and one is right-side hinged. This provides a large entrance to the inside of a cabinet for a customer, when both swing doors open in opposite directions.

There are several ways how to design and further develop the teachings of the present disclosure in an advantageous way. To this end, it is to be referred to the patent claims subordinate to the independent claims on the one hand and to the following explanation of further examples of embodiments of the disclosure, illustrated by the drawing on the other hand. In connection with the explanation of the further embodiments of the disclosure by the aid of the drawing, generally further embodiments and developments of the teaching will be explained.

### BRIEF DESCRIPTION OF THE DRAWINGS

FIG. 1 is a cross-sectional view of part of a swing door system according to an embodiment of the present disclosure.

FIG. 2 is a cross-sectional view of part of a swing door system according to an embodiment of the present disclosure.

FIG. 3 is a cross-sectional view of part of a swing door system according to an embodiment of the present disclosure.

FIG. 4 is a cross-sectional view of part of a swing door system according to an embodiment of the present disclosure.

FIG. 5 is a perspective view of the swing door system according to FIG. 4.

FIG. 6 is a cross-sectional view of part of a swing door system according to an embodiment of the present disclosure.

FIG. 7 is a perspective view of a part of a freezer device according to an embodiment of the present disclosure.

FIG. 8 is a cross-sectional view of part of a swing door system according to an embodiment of the present disclosure.

### DETAILED DESCRIPTION OF THE DISCLOSURE

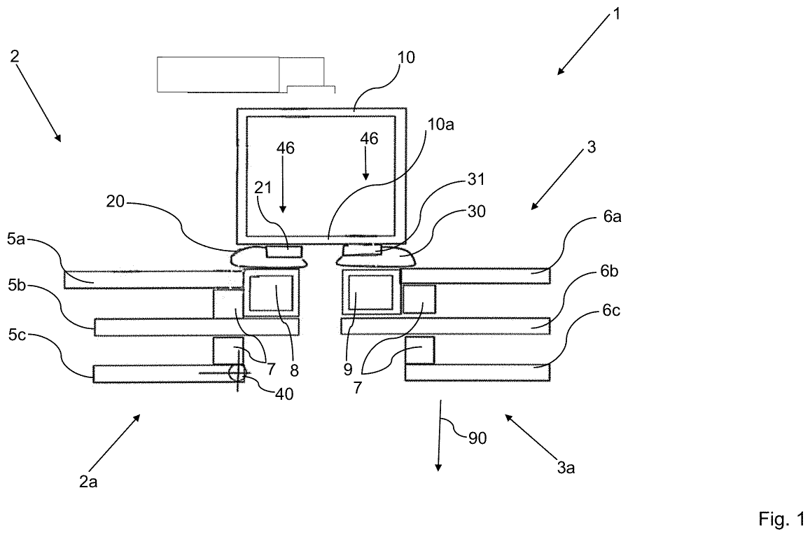

FIG. 1 shows a cross-sectional view of part of a swing door system according to an embodiment of the present disclosure.

In FIG. 1, a swing door system 1 is shown comprising two adjacent swing doors 2, 3. The swing doors 2, 3 each comprise a transparent region 2a, 3a, formed by a plurality of glass panes 5a, 5b, 5c, 6a, 6b, 6c which are spaced apart from each other by spacers 7. The glass panes 5a, 5b, 5c, 6a, 6b, 6c provide insulation between opposite sides of the swing doors 2, 3. The glass panes 5a, 5b, 5c, 6a, 6b, 6c are arranged perpendicular to the opening direction 90 of the swing doors 2, 3. The left swing door 2 can be rotated about a rotating axis 90 being off the center of the swing door 2 in the direction to the outer glass pane 5c. The middle glass panes 5b, 6b of the respective swing door 2, 3 extend as do the other glass panes 5b, 5c in the direction toward the respective other swing door 3, 2 without touching themselves. These extending glass panes 5b, 6b each comprise a quadratic hollow profile 8, 9 being dimensioned such to fill the rectangular space or area formed by the inner respective glass pane 5a, 6b and the difference in length between the inner non-extending glass pane 5a, 6a and the extending glass pane 5b, 6b. The terms “inner” and outer” refer here to the upper and lower area of FIG. 1 being separated by the swing door system 1.

On the surface of each hollow profile 8, 9 is parallel to the glass panes 5a, 5b, 5c, 6a, 6b, 6c in opposite direction of the opening direction 90. Each hollow profile 8, 9 comprises a compressible sealing 20, 30 each provided with a magnet 21, 31, preferably embedded in the respective sealing 20, 30. The magnets 21, 31 interact with a rectangular shaped hollow mullion 10 for providing a force locking, i.e. magnetic, connection 46 for thermal insulation. Both magnets 21, 31 interact with the same surface 10a of the mullion 10 and is arranged parallel to the transparent panes 2a, 3b formed by the glass panes 5a, 5b, 5c, 6a, 6b, 6c. Mullion 10, hollow profiles 8, 9 and spacers 7 in FIG. 1 can be transparent, the sealings 20, 30 can be translucent or transparent.

In general mullion 10, hollow profiles 8, 9, spacers 7 and/or the sealings 20, 30 can be made of or comprise at least one of: transparent plastic, e.g. thermoplastic, in particular PMMA, poly(methyl methacrylate) or polycarbonate or glass.

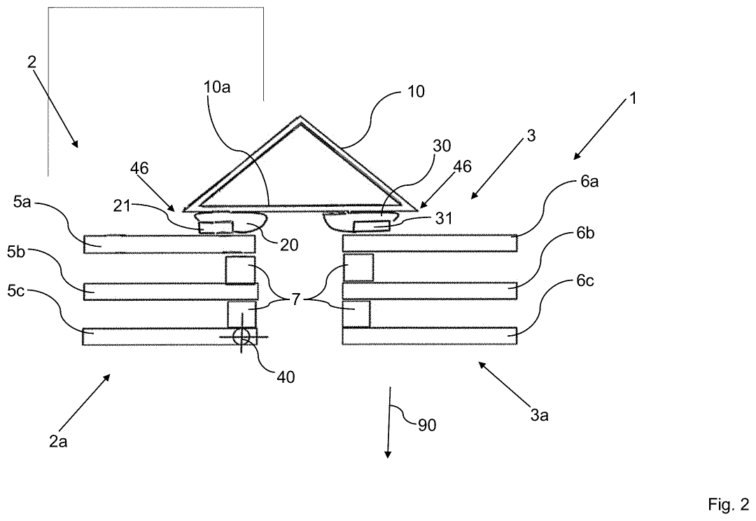

FIG. 2 shows a cross-sectional view of the swing door system according to an embodiment of the present disclosure.

In detail, FIG. 2 shows in general a swing door system 1 according to FIG. 1. The differences between the swing door system 1 according to FIG. 2 and the swing door system 1 according to FIG. 1 is that the swing door system 1 according to FIG. 2 comprises a) a mullion 10 having a triangular form, b) the sealings 20, 30 are attached to the mullion 10 and c) no hollow profiles in or at the swing doors 2, 3 and no extending glass panes 5b, 6b are provided. In detail with regard to the difference a) the mullion 10 has triangular shape in FIG. 2. The triangular shaped mullion 10 is symmetrically arranged with the basis of the “triangle” being parallel to the transparent panes 2a, 3a. The height of the “triangle” is parallel to the opening direction 90. In detail and with regard to difference b) the sealings 20, 30 are attached to the basis of the “triangle”, here formed by the mullion surface 10a. The magnets 21, 31 are attached to the sealing 20, 30 so that they can interact with a corresponding counterpart of the swing door 2, 3, in particular with an element in or with the inner glass panes 5a, 6a. With regard to the difference c) the swing doors 2, 3 both have three glass-panes 5a, 5b, 5c, 6a, 6b, 6c, none of them extends over the other. Mullion 10, and spacers 7 can be transparent, the sealings 20, 30 can be translucent or transparent here in FIG. 2.

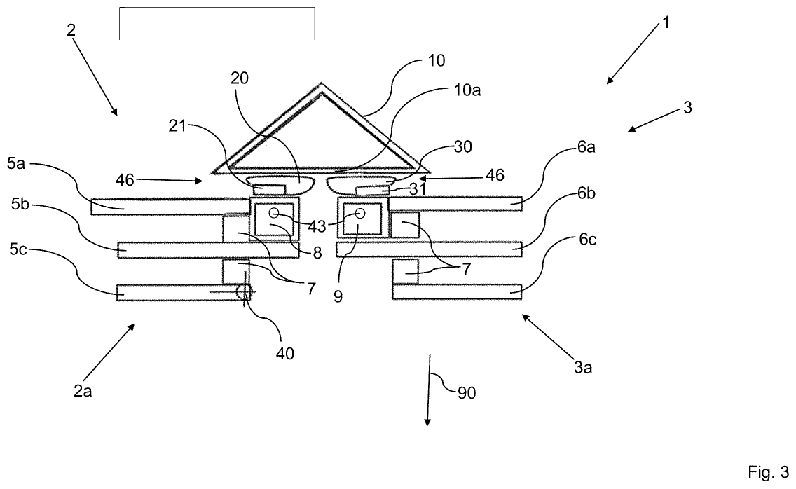

FIG. 3 shows a cross-sectional view of a swing door system according to an embodiment of the present disclosure.

In detail, FIG. 3 shows in general a swing door system 1 with swing doors 2,3 without the attached sealings 20, 30 according to FIG. 1 and a mullion 10 with sealings 20, 30 attached to it according to FIG. 2. Further the hollow profiles 8, 9 attached to the swing doors 2, 3 each comprise a vertically arranged warm air tunnel 43 inside to provide heating of the areas of the swing doors 2, 3 and/or part of the mullion 10 when being in closed position.

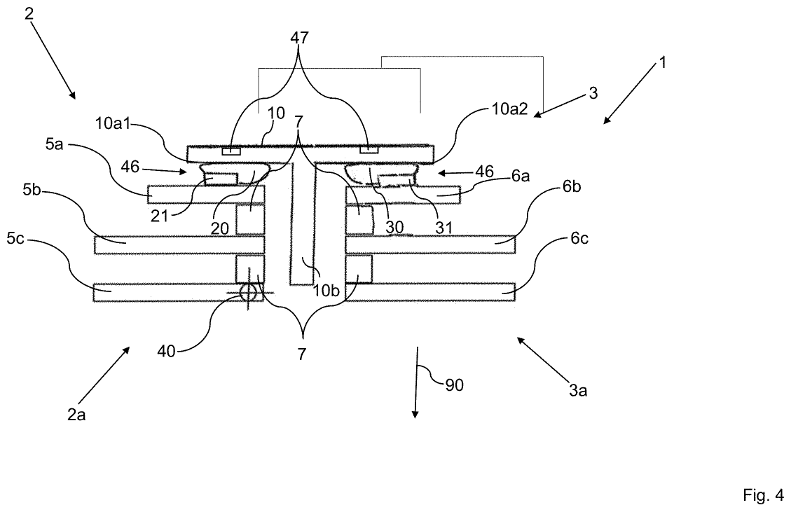

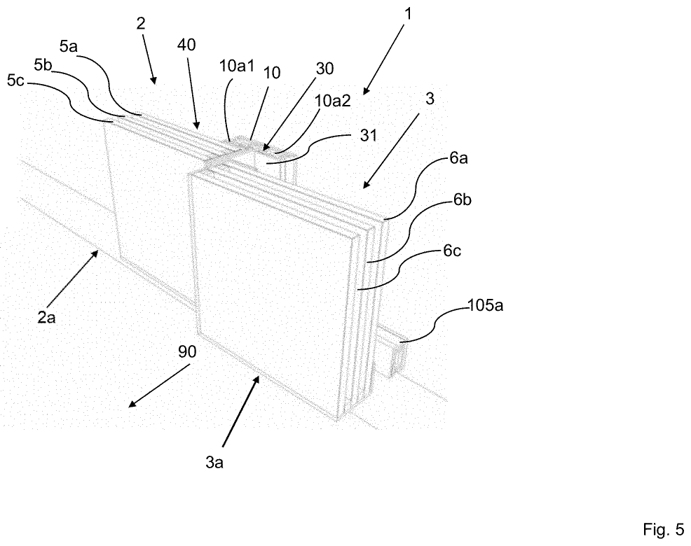

FIG. 4 shows a cross-sectional view of a swing door system according to an embodiment of the present disclosure and FIG. 5 a corresponding perspective view of the swing door system according to FIG. 4.

In detail, FIGS. 4 and 5 show in general a swing door system 1 with swing doors 2, 3 according to FIG. 2 and sealings 20, 30 attached to the mullion 10. However, one of the differences between the swing door system 1 according to FIGS. 4, 5 and the swing door system 1 according to FIG. 2 is that the swing door system 1 according to FIGS. 4, 5 comprise a mullion 10 having a t-shaped form with an arm 10b of the mullion 10 extending between the swing doors 2, 3 in their closed position. Due to the arm 10b there is no common single surface 10a for attaching the sealings 20, 30 at the mullion 10 but two separated surfaces 10a1, 10a2, each being parallel to the transparent panes 2a, 3a of the swing doors 2, 3. Further, the arm of the mullion 10 extending parallel to said transparent panes 2a, 3a comprises light elements 47 on the surface of the mullion 10 on the opposite side of the swing doors 2,3 to illuminate for instance products. Further, the hollow profiles 8, 9 attached to the swing doors 2,3 each comprise a vertically arranged warm air tunnel 43 inside to provide heating of the areas of the swing doors 2,3 and/or part of the mullion 10 when being in closed position. Further in FIG. 5, a lower horizontal profile 105b is shown providing a further stop for the swing door 3 which can comprise a further sealing to interact with the swing door 3. Mullion 10 can be non-transparent, spacers 7 and glass panes 5a, 5b, 5c, 6a, 6b, 6c can be transparent, and the sealings 20, 30 can be translucent here in FIGS. 4, 5.

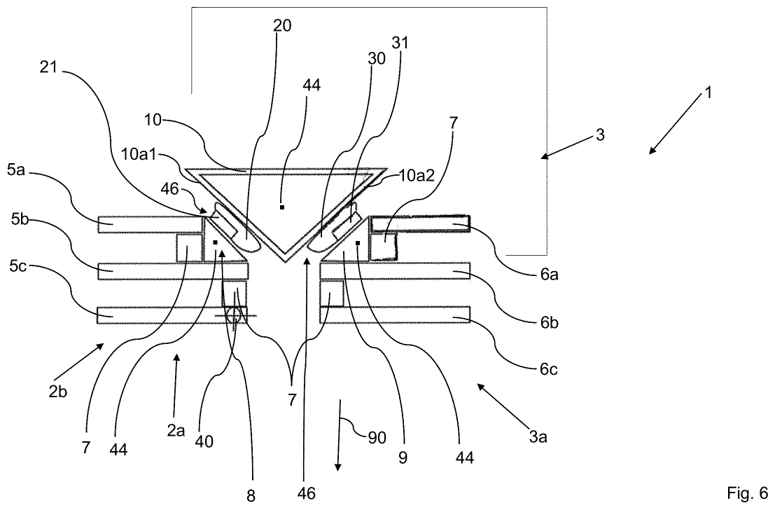

FIG. 6 shows a cross-sectional view of a swing door system according to an embodiment of the present disclosure.

FIG. 6 shows in general a swing door system 1 according to FIG. 3. The differences between the swing doors systems 1 according to FIG. 6 and FIG. 3 are, that the swing door system 1 according to FIG. 6 comprises a triangular shaped mullion 10 with inclined surfaces 10a1, 10a2 against each other. In other words, the mullion 10 of FIG. 6 has been mirrored around the basis 10a of the mullion 10 and the sealings 20, 30 have been attached to these inclined surfaces 10a1, 10a2. Due to this difference between said swing door systems 1, the hollow profiles 8, 9 of the swing doors 2,3 according to FIG. 6 have also triangular shape so that the magnets 21, 31 can interact with a surface of the corresponding profiles 8, 9 parallel to the surfaces 10a1, 10a2 of the mullion 10. A further difference between said swing door systems 1 is that the swing door system 1 according to FIG. 6 has no extending glass panes 5b, 6b but recessed glass panes 5a, 6a so that the triangular shaped profiles 8, 9 can be attached with a side parallel to the transparent panes 2a, 3a to the middle glass pane 5b, 6b and to a surface perpendicular to the glass panes 5a, 6a with the basis of the triangle/hollow profile 8, 9 being parallel to the corresponding inclined surface 10a1, 10a2 of the mullion 10. Mullion 10 can be non-transparent, spacers 7 and glass panes 5a, 5b, 5c, 6a, 6b, 6c can be transparent, and the sealings 20, 30 can be translucent here in FIG. 6. Further, a vertically arranged heating wire 44 in each of the profiles 8, 9 as well as in the mullion 10 is provided.

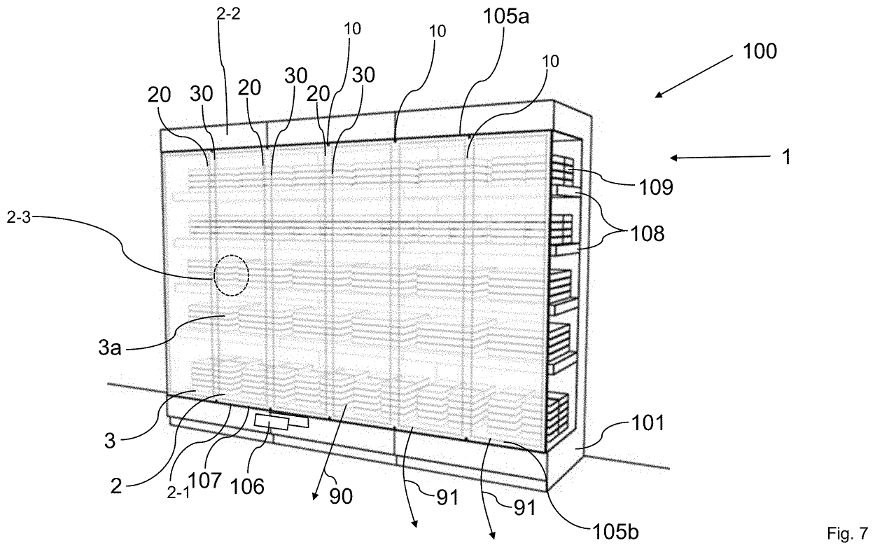

FIG. 7 shows a perspective view of a freezer device according to an embodiment of the present disclosure.

In detail, FIG. 7 shows a freezer device 100 with a swing door system 1. The freezer device 100 comprises a cabinet 101 and further a top horizontal element 105a and a bottom horizontal element 105b. The freezer device 100 comprises six swing doors 2, 3, two of them each forming a swing door system providing a sealing function between them and a corresponding mullion 10. The swing doors 2, 3 each have a transparent region 2a, 3a so that a customer in front of the freezer device 100 can see the products 109 placed on shelves 108 inside the freezer device 100 through the swing doors 2, 3 without having to open the swing doors 2, 3. The sealings 20, 30 the swing doors 2, 3 are transparent.

Further, the horizontal elements 105a, 105b provide a stop for each of the swing doors 2, 3. The opening direction 90 when the swing doors 2, 3 are closed is perpendicular to the swing doors 2,3. The angled direction 91 of the swing doors 2, 3 is the same for all swing doors 2, 3 of the freezer device 100. All swing doors open to the right; therefore all doors are hinged at their right side when looking perpendicular to the transparent panes of the freezer device 100. Further, the freezer device 100 comprises an energy source 106, which is connected with an interface 107 which enables to provide energy to a heating element 43, 44 or light elements 47 inside the swing doors 2, 3. Further, the lower vertical area 2-1, the upper vertical area 2-2 and the area of a handle 2-3 is shown. These areas 2-1, 2-2 and 2-3 are preferred for arranging force-locking elements like magnets 21, 31 or the like, when they are optically non-transparent.

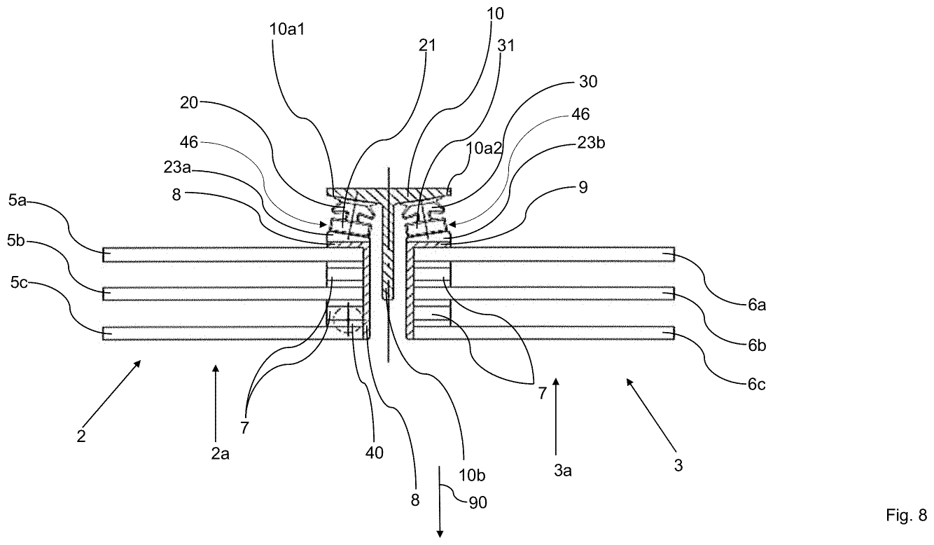

FIG. 8 shows a cross-sectional view of a swing door system according to an embodiment of the present disclosure.

FIG. 8 shows a swing door system 1 comprising two adjacent swing doors 2, 3. Each swing door 2, 3 comprises transparent panes 3a, 3b being spaced from each other by spacers 7. Furthermore, a mullion 10 is arranged. The mullion 10 is T-shaped and comprises a part or arm 10b that reaches between the adjacent swing doors 2, 3, when the swing doors 2, 3 are in the closed position. It is possible that the part/arm 10b is shorter, so that it does not reach in the area between the adjacent swing doors 2, 3. The mullion 10 further comprises surfaces 10a1, 10a2 onto which the sealings or gaskets 20, 30 are fixed, for example glued or snapped into. The adjacent swing doors include wedges 23a, 23b that are made of a material that interacts with the magnets 21, 31 of the gaskets 20, 30. For example, the wedges 23a, 23b are made of steel. The surfaces 10a1, 10a2 of the mullion 10 are inclined with respect to the transparent panes 2a, 3a when the adjacent swing doors 2, 3 are in the closed position. Hence, shear forces are minimized that are acting on the gaskets 20, 30 when the swing doors 2, 3 are opened, i.e. when the magnets 21, 31 are disconnected from the wedges 23a, 23b. Furthermore, the design of the mullion 10 avoids or minimizes shear forces acting on the gaskets 20, 30 during the initial phase when opening the swing doors 2, 3 in the opening direction 90. Both swing doors 2, 3 each have a protective L-shaped profile 8, 9, extending on the swing doors 2, 3 parallel to the extending arm 10b of the mullion and in part on the inner surface of the corresponding glass pane 5a, 6a of the swing door 5, 6, i.e. the surface next to the surfaces 10a1, 10a2 of the mullion 10. On the latter, i.e. the smaller arm of the “L” the wedges 23a, 23b are arranged.

To summarize at least one of the embodiments of the present disclosure provides or enables
high customer comfort
high customer perceived value
simple and cost-effective implementation
large field of view compared with conventional swing door systems
reliable sealing function, thus low energy consumption is enabled
mechanical robustness
stability and rigidity

Many modifications and other embodiments of the disclosure set forth herein will come to mind to the one skilled in the art to which the disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### LIST OF REFERENCE SIGNS

| | |
|---|---|
| 1 | Swing door system |
| 2 | Left swing door |
| 2a | Transparent region |
| 2-1 | Lower section |
| 2-2 | Upper section |
| 2-3 | Handle area |
| 3 | Right swing door |
| 3a | Transparent region |
| 5a | Glass pane |
| 5b | Glass pane |
| 5c | Glass pane |
| 6a | Glass pane |
| 6b | Glass pane |
| 6c | Glass pane |
| 7 | Spacer |
| 8 | Profile left swing door |
| 9 | Profile right swing door |
| 10 | Mullion |
| 10a, 10a1, 10a2 | Surface mullion |
| 10b | Arm |
| 20 | Sealing/gasket |
| 21 | Magnet |
| 23a, 23b | Wedge |
| 30 | Sealing |
| 31 | Magnet |
| 40 | Rotating axis |
| 43 | Warm air tunnel |
| 44 | Heating wire |
| 45 | Heating cable |
| 46 | Force-locking connection |
| 47 | Light element |
| 90 | Opening direction |
| 91 | Angled direction |
| 100 | Freezer device |
| 101 | Cabinet |
| 105a | Top horizontal element |
| 105b | Bottom horizontal element |
| 106 | Energy source |
| 107 | Interface |
| 108 | Shelf |
| 109 | Product |

1. A swing door system for use with a chiller device or freezer device, comprising:
at least one swing door having a closed position;
a mullion; and
a sealing element,
wherein the at least one swing door comprises a transparent pane,
wherein the sealing element is between the swing door and the mullion when the swing door is in the closed position, and
wherein the mullion is at least translucent at least in a part of the mullion.

2. The swing door system of claim 1, wherein the mullion is transparent at least in a part of the mullion.

3. The swing door system according to claim 1, wherein the mullion has a material that provides mechanical stability to the mullion, and the material is at least translucent at least in part.

4. The swing door system according to claim 1, wherein the mullion is fully transparent.

5. The swing door system according to claim 1, wherein the sealing element is at least translucent at least in part of the sealing element and/or wherein the sealing element is compressible.

6. The swing door system according to claim 1, wherein at least one of the mullion and the sealing element comprises at least one force-locking element providing a force-locking connection between the mullion and the at last one swing door.

7. The swing door system according to claim 6, wherein the force-locking element of the sealing element is at a lower and/or upper vertical section of the swing door and/or at a handle.

8. The swing door system according to claim 6, wherein the force-locking element is a magnet, and/or wherein the at least one swing door and/or the mullion comprise a heating element.

9. The swing door system according to claim 8, comprising the heating element, wherein the heating element is a heating wire and/or heating cable, and wherein the sealing element and/or the mullion is translucent in part to hide the heating element.

10. The swing door system according to claim 1, wherein the swing door system comprises a reflective element, and/or wherein the at least one swing door and/or the mullion comprise a light element.

11. The swing door system according to claim 10, wherein the reflective element is a mirror element and/or a reflective coating.

12. The swing door system according to claim 1, wherein the at least one swing door comprises a gas-filled insulating glass unit or a vacuum glass unit, and wherein the gas-filled insulating glass unit or the vacuum glass unit comprises at least two glass panes spaced apart from each other by a spacer element.

13. The swing door system according to claim 12, wherein the spacer is at least partially translucent.

14. The swing door system according to claim 1, wherein the at least one swing door and/or the mullion comprise a hollow profile.

15. The swing door system according to claim 14, wherein the hollow profile and the mullion have essentially the same cross-sectional shape.

16. The swing door system according to claim 14, wherein at the heating element and/or the light element is inside the hollow profile of the at least one swing door and/or the mullion.

17. The swing door system according to claim 14, wherein the hollow profile of the at least one swing door is between at least one glass pane forming the transparent pane of the at least one swing door and the sealing element.

18. The swing door system according to claim 17, wherein the at least one swing door comprises at least two glass panes, wherein one pane extends perpendicular to an opening direction of the at least one swing door the other glass pane, and wherein the hollow profile is attached in the extending region of the extending glass pane.

19. The swing door system according to claim 14, wherein the mullion and/or hollow profile have an essentially rectangular, essentially triangular or essentially t-shaped cross-section and/or wherein the sealing element is attached to the mullion.

20. A swing door system according to claim 1, wherein the at least one swing door has a rotating axis that is in the center of the at least one swing door, wherein the center is defined with respect to the thickness of the at least one swing door perpendicular to the opening direction in a closed position of the at least one swing door and/or wherein the rotating axis of the at least one swing door is off the center of the swing door, and wherein the center is defined with respect to the thickness of the swing door perpendicular to the opening direction in a closed position of the swing door.

21. A freezer or chiller device, comprising:
a swing door system according to claim 1 in a cabinet; and
a second swing door,
wherein the swing doors open in the same direction of an aperture angle.

22. The freezer or chiller device of claim 21, wherein the freezer or chiller device further comprises an upper and/or lower horizontal element to provide a stop for the swing doors of the swing door system.

23. The freezer or chiller device of claim 21, wherein the freezer or chiller device further comprises an energy source for providing heat and/or electric energy and an interface for connecting a heating element, a light element or a sensor of the swing door system to the energy source.

24. A swing door arrangement comprising:
a swing door system according to claim 1;
a second sealing element; and
a second swing door,
wherein the second swing door comprises a transparent pane, and
wherein the second sealing element is between the second swing door and the mullion in a closed position of the second swing door.

25. The swing door arrangement of claim 24, wherein the swing doors form a common plane in a closed position and wherein the mullion provides a single common surface for the sealings of the swing doors, or
wherein the swing doors form a common plane in a closed position and wherein the mullion provides different surfaces for the sealings of the swing doors, wherein the different surfaces are inclined to each other.
